(19) United States
(12) Patent Application Publication
(10) Pub. No.: US 2005/0220100 A1
(43) Pub. Date: Oct. 6, 2005

(54) Device and method for interconnecting network devices

(75) Inventor: Shigeru Kawabe, Tokyo (JP)

Correspondence Address: FOLEY AND LARDNER;SUITE 500, 3000 K STREET NW, WASHINGTON, DC, 20007, US

(73) Assignee: NEC Personal Products, Ltd.

(21) Appl. No.: 11/093,199

(22) Filed: Mar. 30, 2005

(30) Foreign Application Priority Data
Mar. 31, 2004 (JP) 2004-102919

(51) Int. Cl. H04L 12/28

(52) U.S. Cl. 370/389

(57) ABSTRACT

An interconnection device has a plurality of address tables corresponding to respective ones of a plurality of ports. Each address table stores address information of a network device connected to a corresponding port and address management information on a packet sent out from the corresponding port. When a network device is newly connected to a port, address information of the network device is set in a corresponding address table. A packet arriving at a port is forwarded to a selected port by referring to the plurality of address tables and setting address management information on the packet.

### BACKGROUND OF THE INVENTION

1. Field of the Invention

The present invention relates to an interconnection technique used to interconnect a variety of network devices.

2. Description of the Related Art

In an environment in which a plurality of network devices (e.g., personal computers, ADSL modems, network-capable printers, routers, etc.) are present, a device is required to interconnect those devices. For example, in the case of using IP (Internet Protocol), which is a currently predominant protocol in Ethernet standardized by IEEE802.3 and widespread in general, communication is enabled in the following manner. First, from an IP address assigned to each individual device, the address of a network (referred to as a subnet) that the individual device belongs to and the address of the device in the subnet are extracted. Then, in the case of communication between different subnets, the communication is performed via a router and NAT (Network Address Translator). In the case of communication within the same subnet, the communication is performed via a switching hub or the like.

In such a network, communication cannot be performed, unless suitable addresses (and a subnet mask) are assigned to devices and further a connection device is suitably set, with a correct understanding of the IP address mechanism. If one is skilled in the network technology, he/she can correctly use and set these addresses and device. However, in general, the setting of these addresses and device is difficult to understand, and it is not easy to make them operate correctly.

For an interconnection device based on the premise that the interconnection device handles a single subnet, the setting is relatively easy. However, it is difficult to set an interconnection device for interconnecting different subnets, interconnecting the WAN (Wide Area Network) side and the LAN (Local Area Network) side, involving address translation, or the like.

To connect a LAN inside a home to the WAN by ADSL (Asymmetric Digital Subscriber Line), a connection device called a broadband router is widely used today. This broadband router is provided with a port for the connection to the WAN and a port for the connection to a device on the LAN. For these ports, color-coding is used to distinguish between the WAN-side port and the LAN-side port. However, physically, both of the ports are connecters in the same shape with the same number of pina (RJ45 8-pin modular sockets). Therefore, an erroneous connection can be easily caused, such as connecting a cable from a LAN-side device to a WAN-side port. In a switching hub and the like as well, it is difficult to distinguish between a port used for the connection to an upper hub (uplink port) and other ports.

Further, ADSL modems, which are circuit-terminating equipment for ADSL, include those having a router function and/or an address translation function and those merely terminating a circuit and converting signals at a physical-layer level. The ADSL modem having a router function and/or an address translation function will require to be connected to a LAN-side port (its-own-subnet-side port) on a router, whereas the ADSL modem merely terminating a circuit and converting signals at a physical-layer level will require to be connected to a WAN-side port on a router. However, in many cases, this fact is not clearly written on an ADSL modem, or even if written, is not written in such a manner that a general user can understand.

Equipment having a plurality of ports (connectors) to which cables such as 10Base-T and 100Base-T can be connected includes, for example, routers, hubs, and the like. These devices have similar shapes although their uses and connection methods are different from one another. In this respect, there is a possibility that a consumer who is intending to buy a device of one of these types at a store might purchase another type of device by mistake.

In these days, network household electrical appliances and personal computers have come into widespread use at home. Many cases have arisen in which a plurality of network devices are installed in a home and interconnected. It is therefore desired that even a consumer who is not familiar with the network technology can easily, and correctly, interconnect those devices.

Conventionally, only specific users involved in computer and network technologies used interconnection devices and the like. When purchasing a device, many of such users placed importance on ruggedness and the like rather than on design such as the outer appearance of a device. However, as home networking becomes widespread, the users of interconnection devices and the like include an increasing number of general consumers who desire an interconnection device that is as easy to handle as a household appliance or the like. Such consumers place importance on the superiority of design as well as on the flexibility of setting.

Japanese Patent Application Unexamined Publication No. H10-243014 discloses an automatic device detecting apparatus for easy interconnections of network devices. This apparatus can affix a nonstandard bit pattern to the header of a LAN packet outputted from each device, determine the attribute of a device based on the bit pattern, and set a protocol between the device and an interconnection device.

However, since this apparatus uses the nonstandard bit pattern, it is hard to say that this technique can be put into general use.

### SUMMARY OF THE INVENTION

An object of the present invention is to provide an interconnection device which can successfully interconnect a plurality of network devices without the need for complicated setting work, regardless of the purpose of each port.

According to the present invention, an interconnection device is provided with a plurality of address tables corresponding to respective ones of a plurality of ports. Each of the plurality of address tables stores address information of a network device connected to a corresponding port and address management information on a packet sent out from the corresponding port. When a network device is connected to a port, address information of the network device is set in a corresponding address table. A packet arriving at a port is forwarded to an appropriate one of the plurality of ports by referring to the plurality of address tables and setting address management information on the packet.

Each of the plurality of address tables preferably includes: a first table for storing the address management information which comprises a source address, a translated address and a destination address on a packet sent out from the corresponding port; and a second table for storing the address information of the network device connected to the corresponding port. When a network device is newly connected to a port, an inquiry packet is sent out from the port and the second table is set based on a response to the inquiry packet. When receiving a packet having a source address and a destination address thereof at a port, another port from which a received packet is to be sent is selected by referring to the first and second tables, and the received packet is sent from the selected port.

The interconnection device may further include a DHCP (Dynamic Host Configuration Protocol) server section which is selectively set enable and disable. When a DHCP response to a DHCP request sent from a port has been received at the port from another DHCP server, the DHCP server section may be set disable and a location of the other DHCP server is registered. In addition, an address of the interconnection device may be set to an address informed by the other DHCP server.

When the destination address of the packet received at the port does not belong to a subnetwork to which the interconnection device belongs, the source address of the packet is translated to the address of the interconnection device and it is stored as the translated address into the first table corresponding to the port from which the received packet is sent.

When the destination address of the packet received at the port has been registered in any one of the second tables, the received packet may be sent from a port corresponding to the second table registering the destination address of the received packet. When the destination address of the packet received at the port has not been registered in any one of the second tables, the received packet may be sent from all the ports.

When the destination address of the packet received at the port is identical to the address of the interconnection device, the destination address of the packet may be translated to an address corresponding to the source address of the packet by referring to the first table corresponding to the port at which the packet is received, and the received packet may be sent based on a translated destination address.

According to another aspect of the present invention, a control method of the interconnection device includes; a) determining whether a network device is connected to each of the plurality of ports; b) when it is determined that a network device is connected to a port, acquiring address information of the network device connected to the port; c) storing address information of network devices connected to a plurality of ports into a plurality of address tables each corresponding to the plurality of ports; d) when receiving a packet at a port, selecting an appropriate one of the plurality of ports by referring to the plurality of address tables; e) storing address management information on the packet into an address table corresponding to a selected port; and f) sending the packet from the selected port.

As described above, according to the present invention, it is possible to freely connect a network device to an arbitrary port. Further, it is possible to interconnect network devices by carrying out suitable address translation as needed. Therefore, a user can easily configure a network. Moreover, since there is no restriction as to ports for connection, it is possible to enhance the flexibility of device setting, the flexibility of design such as a device appearance, and the flexibility of operation.

In an interconnection device according to the present invention, no distinction is made between a port for LAN and a port for WAN. Moreover, the operation is controlled for each packet by referring to first and second tables. Therefore, normal communication is enabled even when a plurality of subnetworks coexists on the same LAN, or even when three networks or more are connected at the same time. If needed, it is also possible to automatically solve address assignment by allowing the interconnection device to function as a DHCP server.

According to the present invention, when a device is connected, the network setting of each port is checked and thereby made optimal. Accordingly, even a user who is unfamiliar with network setting can easily configure an optimal network.

### BRIEF DESCRIPTION OF THE DRAWINGS

FIG. 1 is a block diagram showing a configuration of an interconnection device according to one embodiment of the present invention;

FIG. 2 is a diagram showing a structure of an address table;

FIG. 3 is a flowchart showing the processing of a main task;

FIG. 4 is a flowchart showing the processing of a packet control task, which is an operation performed when a packet is received; and

FIG. 5 is a block diagram of the interconnection device for explaining a packet flow.

### DETAILED DESCRIPTION OF THE PREFERRED EMBODIMENTS

Hereinafter, it is assumed that an interconnection device according to one embodiment of the present invention operates in accordance with IP (Internet Protocol).

### 1. DEVICE CONFIGURATION

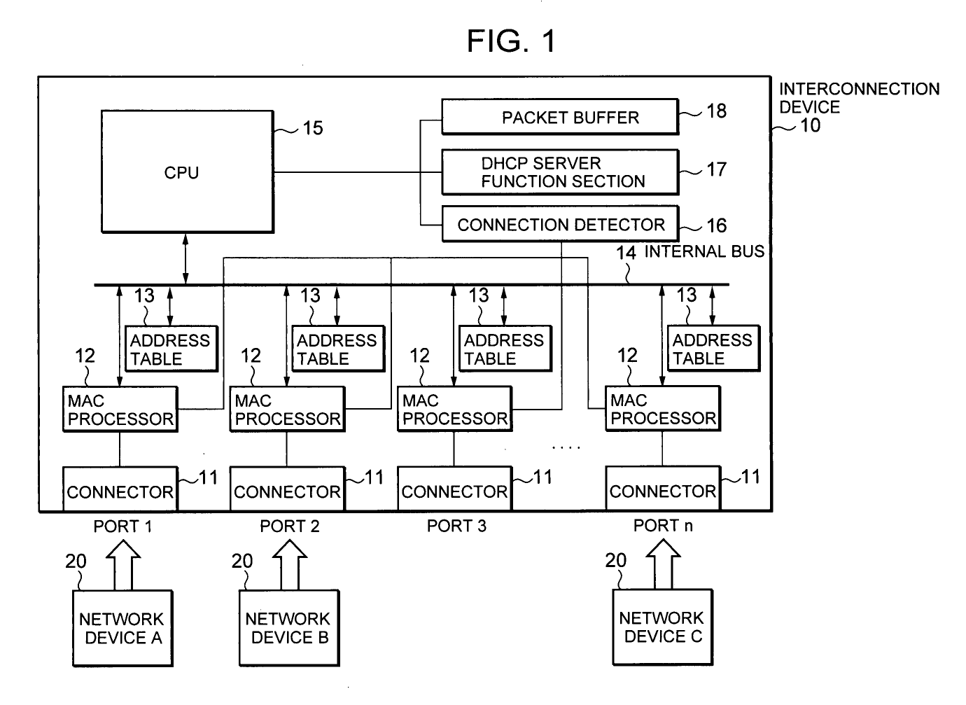

Referring to FIG. 1, a variety of network devices 20 (e.g., a router, a broadband router, an ADSL modem, a personal computer, a network household appliance, a switching hub, a network-capable printer, a wireless LAN access point, etc.) are connected to an interconnection device 10, and the interconnection device 10 enables communications between the connected network devices 20. Specifically, the interconnection device 10 interconnects a plurality of network devices and automatically executes the following functions:
(1) monitoring a connection or disconnection of a network device at all times;
(2) examining, when a network device is newly connected, the IP address of the network device and, if necessary, assigning a new IP address to the network device;
(3) storing the subnet and device addresses of the connected devices into an address table;
(4) when determining that devices are in the same subnet, carrying out packet transmission between them by using a switching hub function; and
(5) when determining that devices belong to different subnets, carrying out address translation, if necessary, and performing routing.

The interconnection device 10 includes a plurality of ports (here, port 1 to port n) each for connecting the network devices 20. Each port is provided with a connecter 11, a MAC processor 12 and an address table 13. To the connector 11, a cable (e.g., a 10Base-T or 100Base-T cable) from a network device 20 is to be connected. The MAC processor 12 is connected to the connector 11 and performs processing at physical layer and at MAC (Media Access Control) layer that is data link layer. The address table 13 manages addresses related to the network device 20 connected to its corresponding port. The connector 11 is typically an RJ45 8-pin modular socket.

Along with the processing at the physical layer and the MAC layer, the MAC processor 12 can determine whether a network device 20 is newly connected to the connecter 11. In this embodiment, by using a publicly known existing technique, the MAC processor 12 performs the processing at the physical layer as follows for example: it determines whether the transmission medium is wired or wireless; determines whether the data transmission rate is 10 Mbps or 100 Mbps; determines whether the communication is full duplex or half duplex; determines whether a cable to be connected is a so-called straight cable or reverse cable; and makes settings based on results of these determinations. Accordingly, at the point in time when a network device 20 is connected to a port, a physical connection is completed.

As shown in FIG. 1, the interconnection device 10 further includes an internal bus 14, a CPU 15, a connection detector 16, a DHCP (Dynamic Host Configuration Protocol) server function section 17, and a packet buffer 18. The CPU 15 implements the functions of the interconnection device 10 by executing software. The connection detector 16 is directly connected to each of the MAC processors 12 and detects a new connection of a network device 20. The DHCP server function section 17 is provided to assign an IP address to the connected network device 20 in accordance with DHCP. The packet buffer 18 stores packet data sent from each device.

Each of the MAC processors 12, each of the address tables 13 and the CPU 15 are connected to the internal bus 14. Moreover, the connection detector 16, the DHCP server function section 17 and the packet buffer 18 are individually connected to the CPU 15. As will be described later, the CPU 15 examines the IP address of a network device 20 connected to a port and executes packet reception, packet translation, packet transmission, and the like.

### 2. ADDRESS TABLE

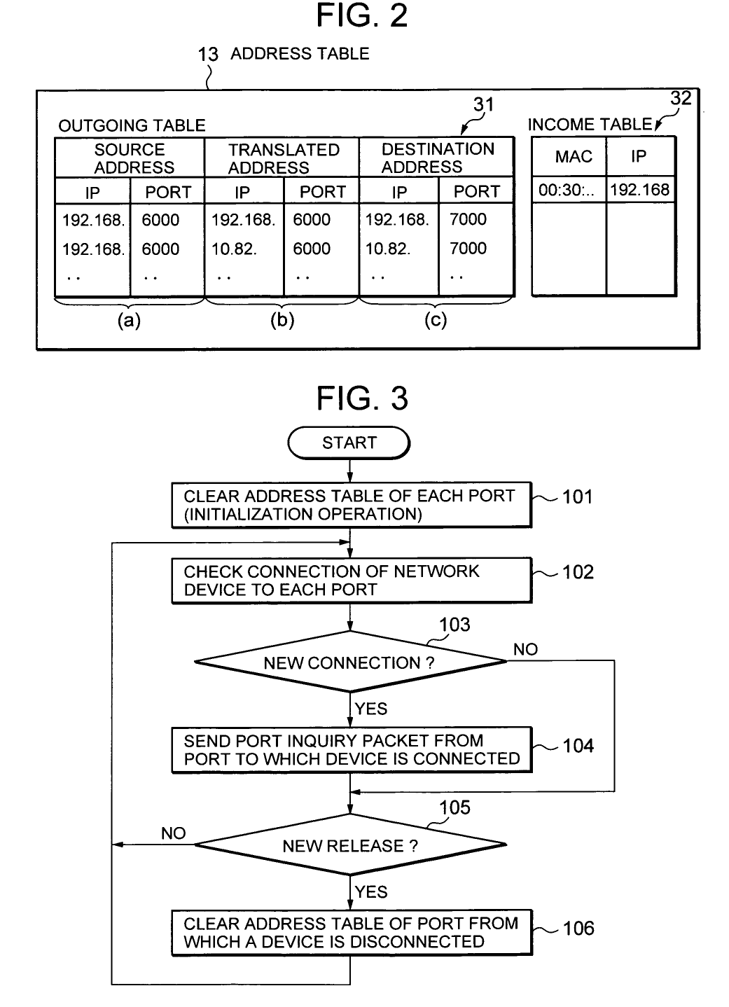

FIG. 2 shows a structure of the address table 13 provided for each port. As mentioned above, the address table 13 manages addresses related to a network device 2C connected to its corresponding port. In each address table 13, an outgoing table 31 and an income table 32 are defined.

The outgoing table 31 stores address management information that is the following address information (IP addresses and port numbers on IP) on a packet sent from the corresponding port: (a) a source address (an IP address and a port number on IP); (b) a translated address which is a source address replaced with the address of this interconnection device 10; and (c) a destination address (an IP address and a port number on IP). Here, in the interconnection device 10, a port number on IP is defined as a service number for specifying an application using TCP (Transmission Control Protocol) or UDP (User Datagram Protocol), which is a upper-level protocol over IP, not a number for specifying a port physically provided as a connecter 11. The port number on IP is required to execute processing such as IP masquerade.

The income table 32 stores the MAC address and IP address of the source of a packet coming into its corresponding port on the interconnection device 10, that is, the MAC address and the IP address that are set on a network device 20 connected to the corresponding port.

Note that, although not shown in the figures, the interconnection device 10 also has a function of storing the location information of another DHCP server, if such a DHCP server exists. The location information indicates a port to which the DHCP server is connected.

### 3. ADDRESS REGISTRATION

For all the ports on the interconnection device 10, the connection detector 16 periodically checks whether a network device 20 is connected to a port, by examining the state of each MAC processor 12. When a new connection of a device to a port is found, the CPU 15 performs network address resolution and registration of resolved address into the address table 13 of the port in question by sequentially executing the following procedures 1 to 5.
Procedure 1: A broadcast packet (specifically, a DHCP request packet, an ARP packet, or the like) is transmitted, as a port inquiry packet, to the newly connected device via the port in question.
Procedure 2: A packet arriving at the port (e.g., a response packet to the packet transmitted in Procedure 1) is awaited.
Procedure 3: The address of the device connected to the port and the subnet information on the device are extracted from the address information included in a packet received, and the extracted information is stored in the income table 32 of the address table 13 provided to the port in question.
Procedure 4: When the packet received in Procedure 2 is a response packet to the DHCP request transmitted in Procedure 1, in which case a DHCP server exists on the device connected to the port in question, the DHCP server function of the interconnection device 10 is disabled, thereby performing no new IP address assignment. Further, the location information of the DHCP server on the connected device is stored so as to deal with a DHCP request that might be received from another device connected to the interconnection device 10.
Procedure 5: When the packet received in Procedure 2 is a DHCP request packet or an address request packet, no IP address is extracted because subnet information and a device address cannot be specified from the received packet.
   Instead, when the DHCP server function of the interconnection device 10 is enabled, an IP address is assigned to the newly connected device. When the DHCP server function of the interconnection device 10 is disabled, the DHCP request packet is transferred using the location information of the DHCP server acquired in Procedure 4 so that the DHCP server of transfer destination will give an IP address to the newly connected device. Thereafter, in any case, the address of the device and the subnet information on the device are stored in the income table 32.

When it is detected that a network device 20 already connected to a port is disconnected from the port, the contents of the address table 13 corresponding to the port are cleared.

Thus, the IP address of a newly connected device is acquired and stored in the income table 32, or an IP address is assigned to a newly connected device.

### 4. PACKET TRANSFER

Next, packet transfer in a stationary state thereafter will be described When receiving a packet from a device connected to the interconnection device 10, the interconnection device 10 checks the destination address of the packet and transfers the packet in accordance with the following rules 1 to 4.
Rule 1: When the destination address is registered in the income table 32 of the address table 13 corresponding to any one of the ports on the interconnection device 10, the packet is transferred to a device connected to the corresponding port. If the packet is to be sent out to a different subnet, the source address of the packet is replaced by the address of the interconnection device 10 when the packet is transferred (NAT function). At this time, the source address, the translated address and the destination address are stored in the outgoing table 31. For example, if the source address is A, the translated address is B, and the destination address is C, then A, B and C are stored in the outgoing table 31 of the port to which the device with its address C is connected when address translation is not required, the translated address B is the same as the source address A. On the other hand, when address translation is carried out, the translated address B is an IP address that is assigned to the interconnection device 10 according to IP masquerade. At the same time, the source address of the packet is replaced by B, and the packet is sent to the destination address C.
Rule 2: When the destination address is a broadcast address, the income table 32 of each port is referred to. If any port is found that belongs to the same subnet that the packet comes from, the packet is transferred to all the ports found. In this case as well, the above-mentioned addresses are stored in each outgoing table 31 similarly to the above.
Rule 3: When the subnet of the destination address is not registered in any address table 13 on the interconnection device 10 (that is, when a connection destination corresponding to the destination address C is uncertain), the packet is transferred to all the ports on the assumption that an unknown network device is connected to any one of the ports or that a gateway exists beyond that device. At this time, similarly to Rule 1, address translation is executed if needed. In this case as well, the addresses are stored in each outgoing table 31 similarly to the above.
Rule 4: As for the address translation executed in Rules 1 to 3, the contents of the translation are temporally registered in the outgoing table 31. However, when a response to a packet with the translated address is not received within a predetermined period of time, the temporally registered contents are deleted from the outgoing table 31.

By repeatedly executing the above-described processing, the address information on a network device connected to a port will be correctly stored in the address table 13 for the port. The respective address tables 13 are provided for each of the ports on the interconnection device 10. As a result, with the interconnection device 10 according to this embodiment, even if a specific network setting is not made, a packet arriving at this interconnection device 10 will be correctly transferred only to a port to which the device with the destination address is connected.

Moreover, since the interconnection device 10 also has the address translation function, it does not matter which port is an upstream (WAN-side) one and which port is a downstream (LAN-side) one. Therefore, the upstream (WAN-side) ports and the downstream (LAN-side) ports can mixedly coexist on the interconnection device 10. However, no port dedicated to the upstream or downstream is defined. Each port is configured to automatically switch between an upstream port and a downstream port depending on a response received from the other end of a communication when a port inquiry packet is transmitted.

To execute the processing as described above, the CPU 15 executes processing called a main task when power is applied to the interconnection device 10. Moreover, each time any of the ports receives a packet, the CPU 15 is interrupted and executes a packet control task. Hereinafter, the main task and the packet control task will be described.

### 5. MAIN CONTROL TASK

Referring to FIG. 3, when powering on the interconnection device 10, the CPU 15 clears the contents of the address table 13 of each port (Step 101). Next, the CPU 15 checks the connection state of each port through the connection detector 16 (Step 102) and determines whether a network device 20 is newly connected (Step 103).

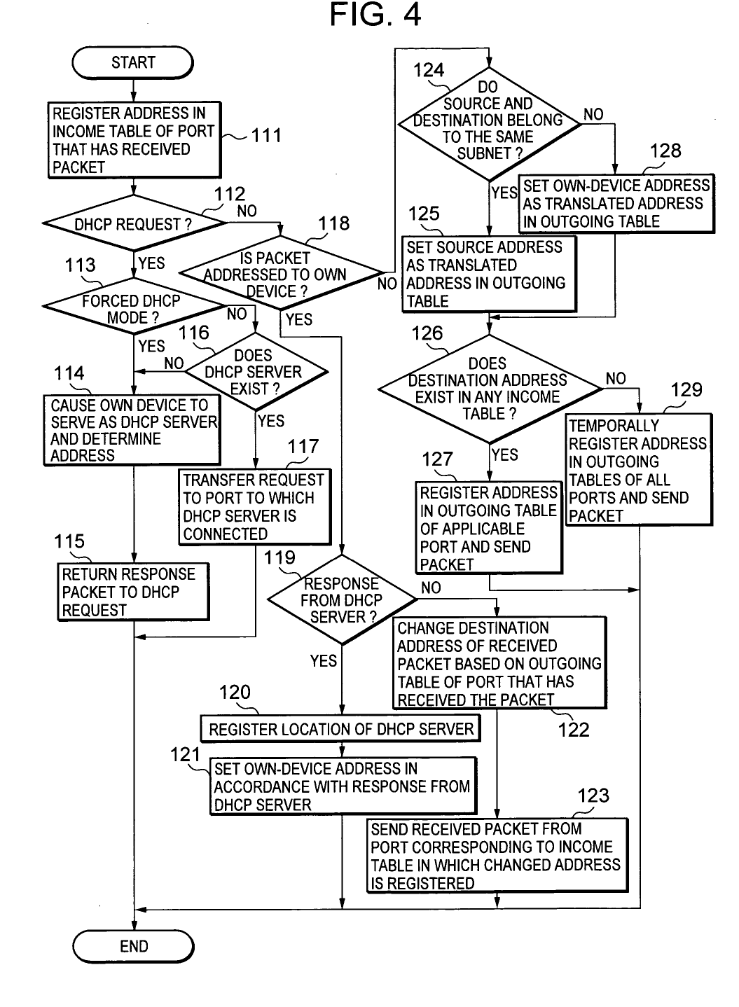

When a new connection is found (YES in Step 103), the CPU 15 sends out a port inquiry packet via the port to which the new connection is made, as described in Procedure 1 above (Step 104). Incidentally, when a response packet to the port inquiry packet is received, the under-mentioned packet control task (see FIG. 4) is activated, thereby processing the response packet. Accordingly, the main task does not include the step of receiving a response packet to the port inquiry packet.

After sending the port inquiry packet (Step 104), or if no new connection is found (NO in Step 103), the CPU 15 determines, based on a result of the check in Step 102, whether there is a port that is newly released (Step 105). In other words, the CPU 15 determines whether or not the release of a connection takes place among the ports to which network devices have been connected. If such a port is not found (NO in Step 105), the CPU 15 returns to Step 102. When such a port is found (YES in Step 105), the CPT 15 clears the address table 13 of the released port (Step 106) and then returns to Step 102. In the main task, the processing from Step 102 through Step 106 is repeated thereafter.

### 6. PACKET CONTROL TASK

Referring to FIG. 4, when any of the ports on the interconnection device 10 receives a packet, the packet control task is activated. First, as described in Procedure 3 above, the CPU 15 registers the address and the like in the income table 32 of the port that has received the packet Step 111). Subsequently, the CPU 15 determines whether the received packet is a DHCP request packet (Step 112).

When the received packet is a DHCP request packet (YES in Step 112), the CPU 15 determines whether the DHCP request indicates a forced DHCP mode (Step 113). If the DHCP request indicates the forced DHCP mode (YES in Step 113), the CPU 15 causes the interconnection device 10 itself to function as a DHCP server and determine an IP address to add to the DHCP request (Step 114). The CPU 15 then sends back a response packet responding to the DHCP request (Step 115) and terminates the task. Needless to say, this response packet notifies the IP address determined in Step 114.

When it is determined that the DHCP request does not indicate the forced DHCP mode (NO in Step 113), the CPU 15 further determines whether another DHCP server exists (Step 116). If another DHCP server does not exist (NO in Step 116), the control of the CPU 15 shifts to Step 114 described above. When another DHCP server exists (YES in Step 116), the CPU 15 transfers the DHCP request to the DHCP server via the port to which the DHCP server is connected (Step 117) and then terminates the packet control task.

In Step 112, when the CPU 15 determines that the received packet is not a DHCP request (NO in Step 112), the CPU 15 determines whether this received packet is a packet addressed to this interconnection device 10 (Step 118). When the received packet is addressed to the interconnection device 10 itself (YES in Step 118), the CPU 15 determines whether the received packet is a response packet from another. DHCP server (Step 119).

When the received packet is a response packet from another DHCP server (YES in Step 119), the CPU 15 registers the location of the DHCP server (Step 120), sets an IP address assigned in the response packet, as the IP address for the interconnection device 10 (Step 121), and then terminates the packet control task.

When it is determined that the received packet is not a response packet from a DHCP server (NO in Step 119), the CPU 15 refers to the outgoing table 31 of the port that has received the packet, and corrects the destination address of the received packet (Step 122).

More specifically, in this case, the received packet is received as a response to a packet in which its source address is replaced by the address of the interconnection device 10 using IP masquerade. The address correction in Step 122 is to correct the destination address of such a received packet. Accordingly, the CPU 15 first retrieves a translated address matching the destination address of the received packet from the outgoing table 31 and reads out the source address corresponding to the retrieved translated address from the outgoing table 31. The CPU 15 then replaces the destination address of the received packet with the source address read out, thus correcting the destination address of the received packet.

Subsequently, the CPU 15 sends the received packet in question from a port corresponding to an income table 32 in which the corrected destination address is registered (Step 123), and then terminates the packet control task.

In Step 118, when it is determined that the received packet is not a packet addressed to this interconnection device 10 (NO in Step 118), the CPU 15 determines whether the source address and destination address of the packet belong to the same subnet (Step 124). When they belong to the same subnet (YES in Step 124), the CPU 15 sets the source address of the packet as the value in the translated address field in the outgoing table 31 (Step 125). If they do not belong to the same subnet (NO in Step 124), the CPU 15 sets the address of this interconnection device 10 as the value in the translated address field in the outgoing table 31 (Step 128).

When the setting in Step 125 or 128 is completed, the CPU 15 examines whether the destination address of the packet exists in the income table 32 of any of the ports (Step 126). When the destination address is found (YES in Step 126), the CPU 15 registers the addresses contained in the packet into the outgoing table 31 of the port in question, sends the packet via the port in question (Step 127), and then terminates the packet control task.

On the other hand, when the destination address does not exist in any of the income tables 32 (NO in Step 126), the CPU 15 registers the addresses included in the packet into the outgoing tables 31 of all the ports, sends out the packet via all the ports (Step 129), and then terminates the packet control task.

The above-described main task and packet control task are performed by the CPU 15 executing programs for Implementing these tasks. Such a set of programs is stored on a storage means (not shown) beforehand and executed by the CPU 15. The programs can be downloaded in the form of firmware through a network. Alternatively, the programs can be read from a nonvolatile memory, such as a memory card, into the storage means.

### 7. EXAMPLE

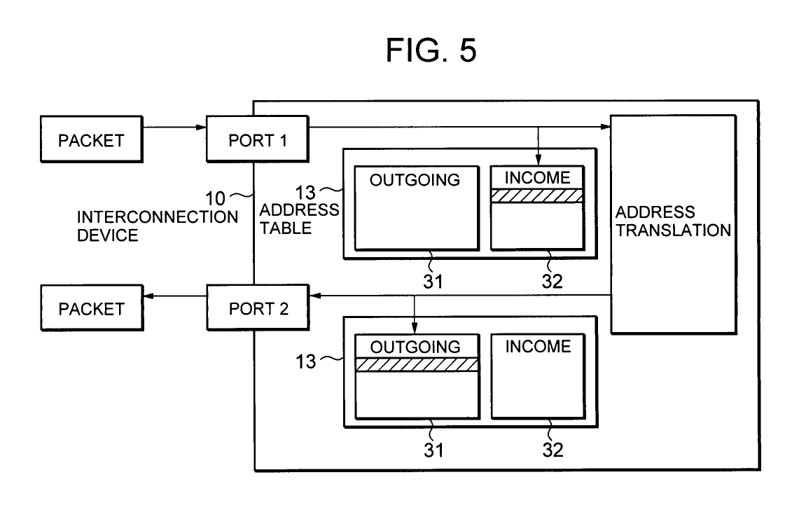

FIG. 5 shows a flow of a packet when the packet arriving at the port 1 is sent out from the port 2. The diagonally shaded areas in FIG. 5 indicate the locations where address information is registered. As can be seen from the figure, on the port at which the packet arrives, the address information is registered in the income table 32, whereas on the port from which the packet is sent out, the address information is registered in the outgoing table 31.

Incidentally, the above-described interconnection device 10 may have a function of manually setting the DHCP service as needed and/or a function of manually defining an IP address for the interconnection device 10 itself when performing IP masquerade Moreover, the interconnection device 10 may be configured such that upstream/downstream for each port, a network address, ON/OFF of the DHCP server function, and the like can be remotely set by using Telnet, HTTP (Hyper Text Transfer Protocol) or the like. These functions, however, are also provided to conventional routers, hubs and the like, whose setting is difficult to understand. Therefore, these are not characteristic aspects on which the interconnection device of the present invention should place emphasis.

Differences between the interconnection device of the present invention and a conventional interconnection device such as a router, switching hub or the like will be described.

In a conventional switching hub, although a table equivalent to the income table of this embodiment is provided for each port, a table equivalent to the outgoing table is not provided. In a conventional router, although a table equivalent to the outgoing table of this embodiment is provided, only one set of such tables is provided and the ports that can use the tables are also restricted. Therefore, with the conventional router, it is required to use the ports with clear distinction between the WAN side and the LAN side. Moreover, the conventional router can transfer a packet only between two different subnets.

In contrast to the foregoing conventional equipment, in the interconnection device 10 according to this embodiment, the outgoing table 31 and the income table 32 are provided for each port. Therefore, on each port, it is not needed to be aware of the WAN side or LAN side, and it is possible to perform correct routing even if a WAN-side cable and a LAN-side cable mixedly coexist. In addition, intercommunications are possible even when three different subnets or more are connected at the same time.

Furthermore, with the interconnection device according to this embodiment, it is possible to connect a cable with no awareness of which port is a WAN-side one and which port is a LAN-side one. As a result, the flexibility of device setting is enhanced, as well as the flexibility of design such as an outer appearance.

For example, in the case of connecting a WAN-side cable coming out of a wall to an interconnection device, if the location of a WAN-side port is limited to one place, the device is generally placed so that the receptacle of the WAN-side port will face the wall. Otherwise the routing of the cable becomes complicated.

However, in the interconnection device according to this embodiment, any of the ports can be used as a WAN-side port. As a result, the cable can be connected to a port into which the cable is most easily inserted. Accordingly the flexibility of device setting is enhanced. It is also possible that conversely, cables from LAN-side devices placed in a room or the like are connected to the interconnection device randomly (or so that the cables are routed with the shortest lengths), and thereafter the WAN-side cable is connected to an arbitrary available port.

The ability to connect a cable to a port without distinguishing between the WAN side and the LAN side can enhance not only the flexibility of device setting but also the flexibility of the design of the interconnection device because, for example, in terms of designing, it is possible to form a side that is desired to be always a front side (a view side).

1. An interconnection device for interconnecting a plurality of network devices, comprising:
a plurality of ports, each of which is connectable to a network device;
a plurality of address tables corresponding to respective ones of the plurality of ports, wherein each of the plurality of address tables stores address information of a network device connected to a corresponding port and address management information on a packet sent out from the corresponding port; and
a controller controlling each of the plurality of address tables such that address information of a network device is set when the network device is connected to a corresponding port, and controlling transfer of a packet arriving at a port to an appropriate one of the plurality of ports by referring to the plurality of address tables and setting address management information on the packet.

2. The interconnection device according to claim 1, wherein each of the plurality of address tables comprises:
a first table for storing the address management information which comprises a source address, a translated address and a destination address on a packet sent out from the corresponding port; and
a second table for storing the address information of the network device connected to the corresponding port,
wherein the controller performs processing of:
when a network device is newly connected to a port, sending out an inquiry packet from the port;
setting the second table based on a response to the inquiry packet;
when receiving a packet having a source address and a destination address thereof at a port, selecting another port from which a received packet is to be sent, by referring to the first and second tables; and
sending the received packet from a selected port.

3. The interconnection device according to claim 2, further comprising a DHCP (Dynamic Host Configuration Protocol) server section which is selectively set enable and disable,
wherein, when a DHCP response to a DHCP request sent from a port has been received at the port from another DHCP server, the controller sets the DHCP server section disable, registers a location of the other DHCP server, and sets its own address to an address informed by the other DHCP server.

4. The interconnection device according to claim 2, wherein, when the destination address of the packet received at the port belongs to a subnetwork different from a subnetwork to which the interconnection device belongs, the controller replaces the source address of the packet with the address of the interconnection device and stores it as the translated address into the first table corresponding to the port from which the received packet is sent.

5. The interconnection device according to claim 2, wherein
when the destination address of the packet received at the port has been registered in any one of the second tables, the controller sends the received packet from a port corresponding to the second table registering the destination address of the received packet; and
when the destination address of the packet received at the port has not been registered in any one of the second tables, the controller sends the received packet from all the ports.

6. The interconnection device according to claim 2, wherein, when the destination address of the packet received at the port is identical to the address of the interconnection device, the controller translates the destination address of the packet to an address corresponding to the source address of the packet by referring to the first table corresponding to the port at which the packet is received, and sends the received packet based on a translated destination address.

7. The interconnection device according to claim 2, wherein the inquiry packet is one of a DHCP request packet and an ARP packet.

8. The interconnection device according to claim 3, wherein the inquiry packet is one of a DHCP request packet and an ARP packet.

9. The interconnection device according to claim 2, wherein each of the plurality of ports comprises a data-link layer processing section which performs processing at physical layer and data-link layer, wherein the controller performs the processing of sending the inquiry packet, setting the second table and sending the received packet at network layer.

10. The interconnection device according to claim 9, wherein the data-link layer is MAC (Media Access control) layer and the network layer is IP (Internet Protocol) layer.

11. A control method of an interconnection device for interconnecting a plurality of network devices, wherein the interconnection device has a plurality of ports, each of which is connectable to a network device, the method comprising:
a) determining whether a network device is connected to each of the plurality of ports;
b) when it is determined that a network device is connected to a port, acquiring address information of the network device connected to the port;
c) storing address information of network devices connected to a plurality of ports into a plurality of address tables each corresponding to the plurality of ports;
d) when receiving a packet at a port, selecting an appropriate one of the plurality of ports by referring to the plurality of address tables;
e) storing address management information on the packet into an address table corresponding to a selected port; and
f) sending the packet from the selected port.

12. The control method according to claim 11, wherein the address management information comprises a source address, a translated address and a destination address on a packet sent out from the corresponding port, wherein the step b) comprises:
b.1) when a network device is newly connected to a port, sending out an inquiry packet from the port; and
b.2) acquiring the address information based on a response to the inquiry packet.

13. The control method according to claim 12, further comprising:.
when a DHCP response to a DHCP request sent from a port has been received at the port from another DHCP server, setting a DHCP server function of the interconnection device disable;
registering a location of the other DHCP server; and
setting an address of the interconnection device to an address informed by the other DHCP server.

14. The control method according to claim 12, wherein the step d) comprises: when the destination address of the packet received at the port does not belong to a subnetwork to which the interconnection device belongs, translating the source address of the packet to the address of the interconnection device, and
the step e) comprises: storing the address of the interconnection device as the translated address of the address management information into the address table corresponding to the port from which the received packet is sent.

15. The control method according to claim 12, wherein the step d) comprises:
when the destination address of the packet received at the port has been registered in any one of the address tables, selecting a port corresponding to the address table registering the destination address of the received packet; and
when the destination address of the packet received at the port has not been registered in any one of the second tables, selecting all the ports.

16. The control method according to claim 12, wherein the step d) comprises: when the destination address of the packet received at the port is identical to the address of the interconnection device, translating the destination address of the packet to an address corresponding to the source address of the packet by referring to the address table corresponding to the port at which the packet is received, wherein the received packet is sent based on a translated destination address.

17. A program product including a computer-readable program which instructs a computer to control an interconnection device for interconnecting a plurality of network devices, wherein the interconnection device has a plurality of ports, each of which is connectable to a network device, the program comprising the steps of:
a) determining whether a network device is connected to each of the plurality of ports;
b) when it is determined that a network device is connected to a port, acquiring address information of the network device connected to the port;
c) storing address information of network devices connected to a plurality of ports into a plurality of address tables each corresponding to the plurality of ports;
d) when receiving a packet at a port, selecting an appropriate one of the plurality of ports by referring to the plurality of address tables;
e) storing address management information on the packet into an address table corresponding to a selected port; and
f) sending the packet from the selected port.
